(19) United States
(12) Patent Application Publication
(10) Pub. No.: US 2025/0086449 A1
(43) Pub. Date: Mar. 13, 2025

(54) GRADIENT DESCENT TUNNELING FOR ERROR-FREE TRAINING

(71) Applicant: Bo Deng, Lincoln, NE (US)

(72) Inventor: Bo Deng, Lincoln, NE (US)

(21) Appl. No.: 18/379,490

(22) Filed: Oct. 12, 2023

Related U.S. Application Data
(60) Provisional application No. 63/537,983, filed on Sep. 12, 2023.

(51) Int. Cl. G06N 3/08

(52) U.S. Cl. CPC G06N 3/08

(57) ABSTRACT

A method of training a neural network comprises executing a neural network training process up to some predefined level of accuracy. The training set is then divided into a set of correctly trained elements and a set of incorrectly trained elements. An auxiliary data set is created from the correctly trained elements and cloned data elements corresponding to the incorrectly trained element. This auxiliary data set is perfectly trained with respect to the trained model for the original data set. A hybrid data set is produced as an average between the original data set and the auxiliary data set. The average is a weighted average according to some weighting parameter. Neural network training then continues to maintain the 100% positive rate from the auxiliary system, iteratively reducing the weighting parameter until the hybrid data set corresponds exactly to the original data set.

### PRIORITY

The present application claims the benefit under 35 U.S.C. § 119 (e) of U.S. Provisional App. No. 63/537,983 (filed Sep. 12, 2023), which is incorporated herein by reference.

### BACKGROUND

Existing neural network training algorithms, especially supervised training algorithms, utilize well annotated data sets to iteratively adjust internode parameters. Training adjusts the parameters and compares outcomes until some threshold or steady state accuracy is achieved.

Neural network training typically produces some acceptable level of accuracy but there is always a minimum error threshold; the error rate stabilizes at a local minimum but cannot progress further. Producing that level of accuracy often requires a number of parameters that are unwieldy to train. For example, in one supervised training of an neural network, the existing training algorithms achieved a 99.87% positive rate with about 1.5 million parameters on the most popular MNIST benchmark data for digits classification.

Let p=(W, b) be the weight parameters and the biases for an neural network with supervised training. Let q=L(p) be the loss function for the neural network with respect to a given training data set D. Denote any local minimum of L by p̅, and denote the global minimum of L, if it exists, by p*. It would be desirable to train the neural network to find the global minimum p*. Currently, training is done by a variety of implementations of the gradient descent method. Specifically, let ∇L(p) denote the gradient of L; starting at an initial guess p₀, and for a learning rate parameter α>0, the next update p is given by an iterative formula

$${P}_{k + 1} = {P}_{k} - α ∇ L ( {p}_{k} )$$

for k=0, 1, 2, . . . . So far, none of the variations has found the global minimum p* with the 100% positive rate for MNIST's full 60,000 training data. In fact, no algorithms have achieved the 100% positive rate for any benchmark data set.

It would be advantageous to have a training algorithm that can train a neural network to perfectly reflect the training set with a reduced set of parameters.

### SUMMARY

In one aspect, embodiments of the inventive concepts disclosed herein are directed to a method of training a neural network. A computer system executes a neural network training process whereby the neural network is trained on an artificial training data set where the global minimum is known or can be reliably found. The artificial training data set is then iteratively modified to converge toward the true training data set, and the neural network is trained on the modified artificial training data set until an updated global minimum is found. The process continues until the artificial training data set coincides with the true training data set, at which point the true global minimum is found.

In a further aspect, the neural network is trained up to some predefined level of accuracy on the true training data set. The true training data set is then divided into a set of correctly trained elements and a set of incorrectly trained elements. An artificial training data set is then created from the correctly trained elements and cloned data elements that correspond to the incorrectly trained elements; each cloned data element may correspond to the closest correctly trained data element.

In a further aspect, the neural network is trained on a hybrid data set, produced as an average between the true training data set and the artificial data set. The average is a weighted average according to some weighting parameter. Neural network training then continues; iteratively reducing the weighting parameter until the hybrid data set corresponds exactly to the true training data set. The neural network is then trained to perfect accuracy.

It is to be understood that both the foregoing general description and the following detailed description are exemplary and explanatory only and should not restrict the scope of the claims. The accompanying drawings, which are incorporated in and constitute a part of the specification, illustrate exemplary embodiments of the inventive concepts disclosed herein and together with the general description, serve to explain the principles.

### BRIEF DESCRIPTION OF THE DRAWINGS

The numerous advantages of the embodiments of the inventive concepts disclosed herein may be better understood by those skilled in the art by reference to the accompanying figures in which:

FIG. 1 shows a block diagram of a neural network useful for implementing embodiments of the present disclosure;

FIG. 2 shows graphs of local and global minimums of a neural network according to an exemplary embodiment;

FIG. 3 shows a graph corresponding to training iterations of a neural network according to an exemplary embodiment;

FIG. 4 shows a flowchart of a method according to an exemplary embodiment;

### DETAILED DESCRIPTION

Before explaining various embodiments of the inventive concepts disclosed herein in detail, it is to be understood that the inventive concepts are not limited in their application to the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of a feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Also, while various components may be depicted as being connected directly, direct connection is not a requirement. Components may be in data communication with intervening components that are not illustrated or described.

Finally, as used herein any reference to “one embodiment,” or “some embodiments” means that a particular element, feature, structure, or characteristic described in connection with the embodiment is included in at least one embodiment of the inventive concepts disclosed herein. The appearances of the phrase “in at least one embodiment” in the specification does not necessarily refer to the same embodiment. Embodiments of the inventive concepts disclosed may include one or more of the features expressly described or inherently present herein, or any combination or sub-combination of two or more such features.

Broadly, embodiments of the inventive concepts disclosed herein are directed to a method of training a neural network. A computer system executes a neural network training process whereby the neural network is trained on an artificial training data set where the global minimum is known or can be reliably found. The artificial training data set is then iteratively modified to converge toward the true training data set, and the neural network is trained on the modified artificial training data set until an updated global minimum is found. The process continues until the artificial training data set coincides with the true training data set, at which point the true global minimum is found.

In a further aspect, the neural network is trained up to some predefined level of accuracy on the true training data set. The true training data set is then divided into a set of correctly trained elements and a set of incorrectly trained elements. An artificial training data set is then created from the correctly trained elements and cloned data elements that correspond to the incorrectly trained elements; each cloned data element may correspond to the closest correctly trained data element. The global minimum of such an artificial training data set is easily found.

In a further aspect, the neural network is trained on a hybrid data set, produced as an average between the true training data set and the artificial data set. The average is a weighted average according to some weighting parameter. Neural network training then continues; iteratively reducing the weighting parameter until the hybrid data set corresponds exactly to the true training data set. The neural network is then trained to perfect accuracy.

It may be appreciated that embodiments of the present disclosure are embodied in a computer apparatus including at least one processor, or are implemented via a computer apparatus including at least one processor. Within the context of the present disclosure, “processor” may refer to any processing technology suitable for the described tasks, including general purpose programmable processors, neuromorphic in situ (chip) implementation, photonic in situ (chip) implementation, and polaritonic in situ (chip) implementation, any combinations with digital implementations, or the like.

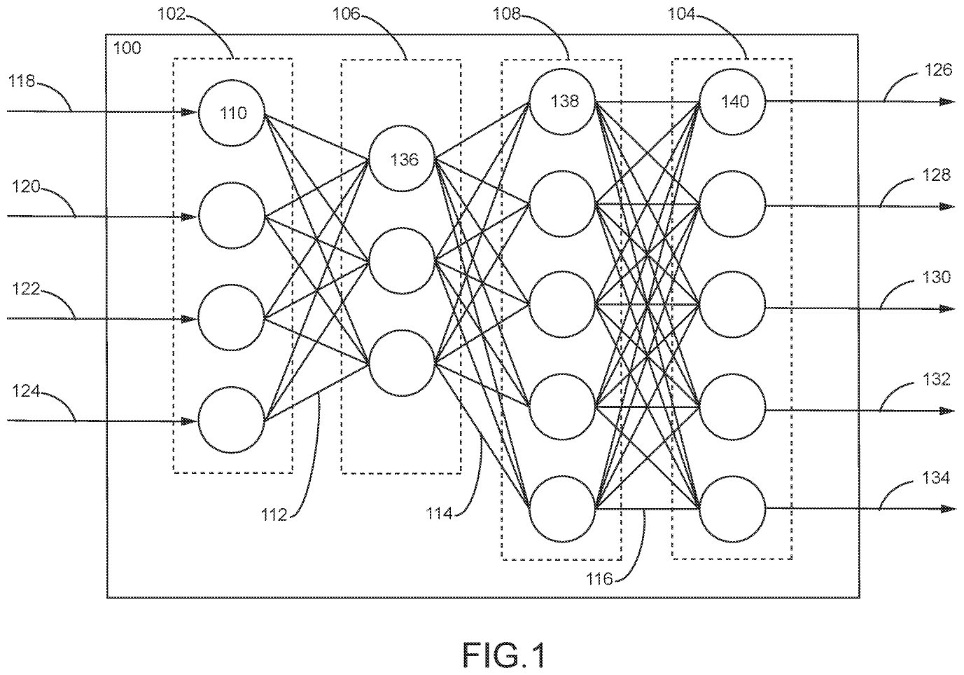

Referring to FIG. 1, a block diagram of a neural network useful for implementing embodiments of the present disclosure is shown. The neural network 100 comprises an input layer 102, and output layer 104, and a plurality of internal layers 106, 108. Each layer comprises a plurality of neurons or nodes 110, 136, 138, 140. In the input layer 102, each node 110 receives one or more inputs 118, 120, 122, 124 corresponding to a signal and produces an output 112 having a unique set of synaptic weights corresponding to each input node 110 and activation biases. Different connections 114, 116 may utilize different synaptic weights and biases. Furthermore, it is envisioned that certain connective edges 112, 114, 116 may utilize a weighted input summation methodology while others utilize a weighted input product methodology. It is further envisioned that synaptic weight may correspond to bit shifting of the corresponding inputs 112, 114, 116. It is further envisioned that an implementation can be digital, analog, optical, and/or polaritonic, in software code and/or on hardware in-situ, or some combination and/or modification thereof, such as neuromorphic, optical, and/or polaritonic implementations for artificial neural networks.

Outputs 112 from each of the nodes 110 in the input layer 102 are passed to each node 136 in a first intermediate layer 106. The process continues through any number of intermediate layers 106, 108 with each intermediate layer node 136, 138 having a unique activation function. An activation function may be a hyperbolic tangent function, a logistic function, a rectified linear unit function, or some combination and/or modifications thereof. Different nodes 110, 136, 138, 140 may utilize different types of activation functions. It is envisioned that certain intermediate layer nodes 136, 138 may produce a real value with a range while other intermediated layer nodes 136, 138 may produce a Boolean value. It is further envisioned that an implementation of activation at nodes 110, 136, 138, 140 can be digital, analog, optical, and/or polaritonic, in software code and/or on hardware in-situ, or some combination and/or modification thereof, such as neuromorphic, optical, and/or polaritonic implementations for artificial neural networks.

An output layer 104 including one or more output nodes 140 receives the inputs 116 from each of the nodes 138 in the previous intermediate layer 108. Each output node 140 produces a final output 126, 128, 130, 132, 134 via processing the previous layer inputs 116 by a classifier function such as a softmax function, a sigmoid function, a logistic function, a cross-entropy function, and/or in situ digital or analog classifier. Such outputs may comprise separate components of an interleaved input signal, bits for delivery to a register, or other output based on an input signal and DSP algorithm. Outputs of 104 are utilized to create a loss function against training labels of input layer 102. Such a loss function can be a squared distance function between outputs of 104 and an equivalence of training labels, a maximum likelihood function, a logarithmic loss, log loss or logistic loss, and/or an entropic loss function; in situ digital or analog gain or loss in voltage, current, power, or some combination and/or modification thereof, such as neuromorphic, optical, and/or polaritonic implementations.

Each synaptic weight corresponds to a parameter that must be adjusted during training. Training the neural network 100 may be by supervised or unsupervised training. In at least one embodiment, the neural network 100 may be trained according to an algorithm such as stochastic gradient descent, surrogate-backpropagation in spiking neural network, Monte Carlo simulation. Existing methodologies utilize such training algorithm to arrive at a set of synaptic weights with some error rate. The error rate corresponds to a local minimum of a loss function. It may be appreciated that error rates for a neural network may define any number of local minima, but only one potential global minimum that would only be arrived at by chance if the training process happened to begin in a valley including the global minimum. Outside that valley, the training process would always arrive at a local minimum instead. Parameter adjusting for training can be digital, analog, optical, and/or polaritonic, in software code and/or on hardware in-situ, or some combination and/or modification thereof, such as neuromorphic, optical, and/or polaritonic implementations for artificial neural networks.

It may be appreciated that the representation in FIG. 1 is exemplary in nature. Other architectures are envisioned, such as convolutional neural network (CNN), spiking neural network (SNN), recurrent neural network (RNN), long short-term memory network (LSTM). The principles described herein are applicable to other neural network implementations.

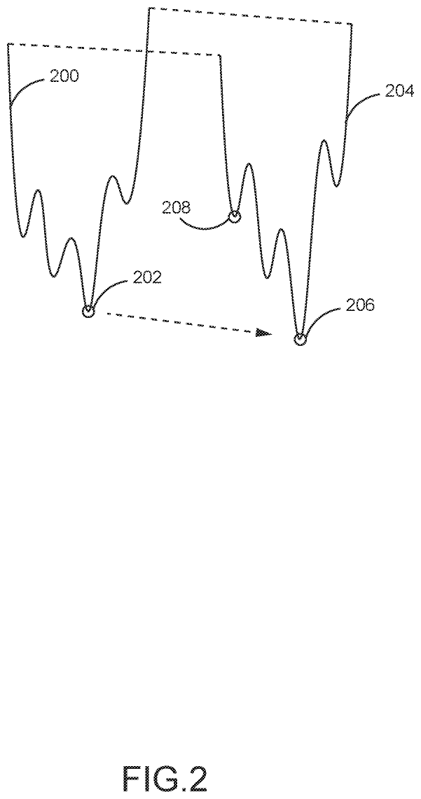

Referring to FIG. 2, loss function landscape graphs 200, 204 of local and global minima of a neural network according to an exemplary embodiment are shown. A neural network training process produces a local minimum 208; the local minimum 208 is typically where a training method ends. Conventional methods search for a minimum on the surface of a loss function's landscape graph 204; it would be desirable to arrive at a global minimum 206, current training method offers no mechanism to find the global minimum 206.

Embodiments of the present disclosure find the global minimum 206 below the landscape by tunneling from a global minimum 202 of a loss function's landscape graph 200 for an artificially constructed data set. The artificially constructed data set may converge to the true data set by adjusting a parameter λ from 0 to 1 as described herein.

The theoretical basis for the method is based on an equivalent setting for the conventional training method. Specifically, training the neural network from any p₀ finds the gradient flow path p(t), satisfying the induced gradient system of equations:

$$\dot{p} ( t ) = - ∇ L ( p ( t ) ) , with p ( 0 ) = {p}_{0}$$

for the initial condition.

All conventional gradient descent methods are discrete approximations of the gradient flow p(t). For example, the basic searching algorithm described above is a numerical implementation of Euler's method for ordinary differential equations for the gradient system of equations above. In this equivalent setting, any local minimum point of the loss function is a stable equilibrium of the gradient system. The converse is also true. Specifically, let ϕₜ(p₀) denote the solution operator of the gradient system satisfying the initial condition:

$${ϕ}_{0} ( {p}_{0} ) = {p}_{0} .$$

The solution p(t) to the gradient system with the initial condition p(0)=p₀ is p(t)=ϕₜ(p₀). That is, ϕₜ: [symbol] → [symbol] defines a transformation or mapping from [symbol] to itself for every time t. Thus, the subscript 0 can be dropped and ϕₜ(p) can be used to denote the solution operator, mapping point p to ϕₜ(p) after time t>0. Every local minimum p̅ of the loss function L is a locally stable fixed point of the solution operator ϕₜ(p) for every t≥0:

$${ϕ}_{t} ( \overline{p} ) = \overline{p} , t \geq 0.$$

Conversely, every locally stable fixed point of ϕₜ is a local minimum point of L. In addition, a fixed point of ϕₜ for one fixed nonzero t, (e.g., t=1), is a fixed point of ϕₜ for all t>0. Therefore, it is only necessary to consider the solution operator at one fixed time, (e.g., t=1, T(p):=ϕₜ(p)). Such a map is called a Poincaré map. The conclusion is, a point p̅ is a locally stable fixed point of the Poincaré map T if and only if p̅ is a local minimum of the loss function L.

Existing theory is applied to supervised training on one set of training data. Consider a set of training sets of data, denoted by D_{λ} where λ is a parameter from a compact interval, (e.g., 0≤λ≤1). For each λ∈[0,1], it is desirable to find the global minimum p_{λ}* for the same neural network model on training data D_{λ} whose corresponding loss function can be denoted by L_{λ}. This type of training may be considered a parameterized training with parameter λ or a parameterized co-training.

In terms of the Poincaré mapping equivalency, for each λ, the equivalent Poincaré map T_{λ} for which p̅_{λ} is a local minimum for L_{λ} if and only if p_{λ} is a locally stable fixed point of T_{λ}.

Embodiments of the present disclosure are based on the Continuation Theorem of Global Minimums. If the global minimum point p_{λ}*∈ [symbol] of L_{λ} exists for every λ∈[0,1] and the Poincaré map T_{λ} is continuous in λ and is differentiable at p_{λ}*, then the global minimums form a continuous path γ:={p_{λ}*: 0≤λ≤1} in the training parameter space [symbol] . For each co-train parameter λ∈[0,1], let DT_{λ}(p_{λ}*) be the linearization of the Poincaré map T_{λ} at the fixed point p_{λ}*. Let ρ(p) be a C^{∞} cut-off scalar function in a small neighborhood U_{λ} of p_{λ}*. Extend T_{λ} from U_{λ} to the entire space [symbol] ⁿ by:

$${T}_{λ} ( p ) \to D {T}_{λ} ( {p}_{λ}^{*} ) p + ρ ( p - {p}_{λ}^{*} ) [ {T}_{λ} ( p ) - D {T}_{λ} ( {p}_{λ}^{*} ) p ]$$

For a small enough neighborhood U_{λ}, the extended map is a contraction mapping in [symbol] . Without loss of generality, consider the same notation T_{λ} for the extended map. Because λ is from the compact interval [0,1], the extended map T_{λ} can be made to be uniformly contracting for all λ∈[0,1]. As a consequence, by the Uniform Contraction Mapping Theorem, for each λ, T_{λ} has a unique fixed point which by construction is exactly the global minimum point p_{λ}*; for L_{λ}. Also, as a consequence to the Uniform Contraction Mapping Theorem, the set of points {p_{λ}*: 0≤λ≤1} form a continuous path in the training parameter space [symbol] that is parameterized by the co-train parameter λ.

In at least one embodiment, the neural network model is trained by any conventional means to achieve a significant positive rate (e.g., 80%). The data set D is divided into correctly labelled or trained data elements Dₜ, and incorrectly labelled or untrained data elements Dᵤ.

An artificial data set D̅ is constructed from Dₜ and a set of cloned data elements D̅ᵤ. The cloned data elements D̅ᵤ are cloned from Dₜ for the same number as Dᵤ. In at least one embodiment, for each incorrectly labelled data from Dᵤ, a best-trained partner data element is found from Dₜ, preferably with the same label.

The artificial data set D̅ is a joint data set D̅=Dₜ+D̅ᵤ; either perfectly trained for the neural network model with the same weight parameter and bias p={W, b} as the imperfectly trained but true data D, or in the basin of convergence of its global minimum and thus the auxiliary neural network model can be perfectly trained. The corresponding system with D̅ is referred to as a training partner, and the imperfectly trained parameters p correspond to the global minimum for the partner system automatically (i.e., p=p̅*).

The parameter λ is in the interval [0,1]. For each λ, create a hybrid data set D_{λ} from the true data D and the artificial partner data set D̅:

$${D}_{λ} = ( 1 - λ ) \overline{D} + λ D$$

In at least one embodiment, the perfectly trained data set Dₜ remains unchanged for all 0≤λ≤1. The part corresponding to the erred data changes from the perfectly trained partner set D̅ᵤ at λ=0 to the original data set Dᵤ at λ=1. The technique utilizing weighted averages of D̅ and D with weight (1−λ) and λ, respectively, is known as homotopy for continuation in mathematics.

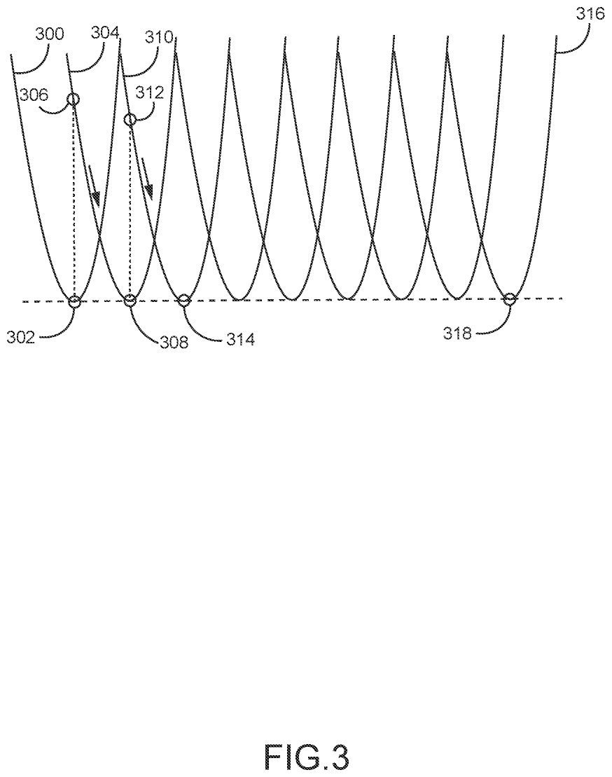

For the neural network model with the hybrid data set D_{λ} from λ=0 to λ=1, the Continuation Theorem of Global Minimums described above guarantees the error-free global minimum at λ=0 is connected all the way through 0≤λ≤1 to the error-free global minimum at λ=1. Continuation of the global minimum from λ=0 to λ=1 converges for the global minimum of the hybrid data set D_{λ} to the global minimum of the original data set D. Such convergence may be implemented by the Backtrack Correction method shown in FIG. 3.

Referring to FIG. 3, a graph corresponding to training iterations of a neural network according to an exemplary embodiment is shown. Starting at λ=0 where the global minimum 302 is known for the partner system training data set loss function 300, λ is iteratively updated by some value toward λ=1.

The global minimum 302 for the partner system training loss function 300 at λ=0 corresponds to a point 306 directly above on a partner system training loss function 304 at λ=λ₁<1 for the same parameter point p in the parameter space [symbol] relative to different continuation parameter values. The point 306 lies inside the basin of attraction, or the potential well, of the global minimum 308 for a forwarding co-train parameter value λ₁.

During a continuation process, λ is moved to a value λ=a. The value a should be selected such that the attraction well of the global minimum for the loss function at λ=a overlaps with the global minimum at λ=0. The continuation process then applies a searching algorithm to find the global minimum at λ=a. As shown in FIG. 3, a=λ₁. If the step taken if too large, say, a=λ₂, 314, then the system may miss the attraction well of the global minimum at a, and a subsequent searching will lead the hybrid system to a local minimum. This occurrence will be detected by a nonzero error-rate of the hybrid system. In such case, the step size is reduced to a smaller a.

This continuation process iterates until a smaller λ value is found at which the global minimum is continued for the hybrid system. The theorem guarantees for typical systems the number of backtrack iterations is finite and the new global minimum 308, 314 will be located for non-zero a ahead λ=0. The steps are repeated from the new global minimum 308, 314. When this continuation process reaches λ=1, the global minimum 318 for the true system (i.e., true training loss function 316) is found, and the fully-trained system is error-free. Before the error-free global minimum 318 is reached for the true system, the true system will be trained with arbitrarily small error-rates because of the Continuation Theorem of Global Minimums.

Continuation of the global minimums 302, 308, 314, 318 from λ=0 to λ=1 can be done in any continuation method. For example, it can be done by solving for equilibrium solutions for the gradient vector field:

$$∇ {L}_{λ} ( p ) = 0$$

by Newton's method or its variations, starting at the partner system's global minimum 302 p₀* at λ=0.

A continuation process can be sped up by adaptively increasing the step-size a if the iterations produce a consecutive sequence of error-free hybrid global minima. The length of such a sequence can be predetermined or varying. In the event that an increased step-size is too large to produce a global minimum for the hybrid system, the Backtrack Correction is applied to rest the error-free continuation.

An original training data set D can be a collection of different types, e.g., D=A+B of which A is a set of handwritten digits, B is a set of audio recordings of digits, both are trained together by shared labels. An artificial partner data set D̅=Ā+B̅ is created as λ=Aₜ+Āᵤ and B̅=Bₜ+B̅ᵤ so that Āᵤ is cloned from its own type Aₜ and B̅ₜ is cloned from its own type Bₜ.

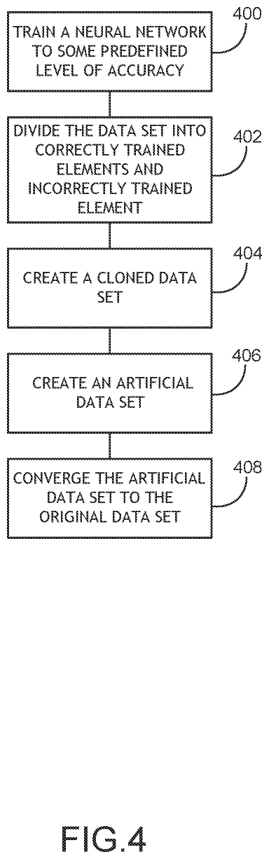

Referring to FIG. 4, a flowchart of a method according to an exemplary embodiment is shown. A training system trains the neural network to some predefined level of accuracy where the trained neural network produces correct results for some elements in the training data set (e.g., correctly categorizing some set of elements). The neural network may be trained to some local minimum, but a local minimum is not necessary or even desirable.

The data set is then divided into a set of correctly trained elements and incorrectly trained elements. The system then creates a cloned data set. Each data element in the cloned data set corresponds one of the incorrectly trained data elements. In at least one embodiment, a correctly trained data element is selected from the set of correctly trained elements, closely corresponding to an incorrectly trained data element. For example, the system may select a correctly trained data element with data tags identical to an incorrectly trained data element.

The system creates a hybrid data set wherein the cloned data set is added to the correctly trained data set (i.e., incorrectly trained data elements are replaced with cloned data elements). Then the system continues training the neural network based on the hybrid data set.

The system iteratively trains the neural network on the hybrid data set until training process arrives at a global minimum for the hybrid data set (i.e., zero error). The hybrid data set is then adjusted by changing the parameter λ as described herein. If, for any iteration, the system fails to arrive at a global minimum, the system reverts to a prior iteration and uses a smaller change in λ. The process continues until λ=1, indicating that a global minimum for the original data set is reached.

Conceptually, the hybrid data set is a weighted average of the original data set and a data set where data elements that produce an error are replaced with close matches that are known not to produce an error. The parameter λ corresponds to a weighting factor that shifts the average from the auxiliary data set with cloned values toward the original data set.

Embodiments of the present disclosure produce a global minimum by artificially producing a data set with a known global minimum, and iteratively shifting the data set (along with the known global minimum) until a global minimum for the original data set is reached.

One direct implication of the continuation method is that the trained data Dₜ represents what has been learned by the neural network model, and the erred data Dᵤ represents new data to be learned. The co-train continuation method together with method described in this disclosure can be used to accomplish such memory retention learning tasks so that the model is trained to the new data while keeping the learned data intact.

Experimental applications have achieved 100% positive rate for the MNIST benchmark data with neural network models having one hidden layer with 100, 80, 60, 40, 20 hidden nodes, respectively. The corresponding numbers of parameters in {W, b} for the model are 79510, 63610, 47710, 31810, 15910, respectively. The experimental application used ReLU for the activation function and the softmax for the classification function for the neural network model. Although the loss function is not differentiable everywhere, it is Lyapunov continuous. In addition, at the global minimum points, the loss function is expected to be differentiable as a generic property because it is probability zero for a global minimum point to encounter the non-differentiable point of ReLu. As a result, the Continuation Theorem of Global Minimums is expected to apply for all practical problems, as long as there are sufficiently many parameters with respect to the number of classification labels which guarantees the existence of the global minimum for the loss function.

An error-free training method is applicable for all supervised trainings of neural networks, including convolutional neural networks, recurrent neural network, LSTM, spiking neural networks, optical neural networks, polaritonic neural networks, etc. It may be even more advantageous due to the relatively small numbers of model parameters required, reducing the carbon-footprint for AI training. It will make any high error-rate but low energy-cost systems more or equally competitive because of their energy efficiency, such as spiking neural networks, optical neural networks, and polaritonic neural networks. Embodiments of the present disclosure may be implemented on platforms from cloud-frame supper computers to microchips on mobile devices. The error-free learning capability of the method will enable AI to fully enter into many fields requiring low error-rate automation, such as precision manufacturing, robotic operations, record keeping, human resource management, health care management, pharmaceutical and medical expert systems. Embodiments may be used to build error-free modular systems for search engines and for large language models which are trained unsupervised.

It is believed that the inventive concepts disclosed herein and many of their attendant advantages will be understood by the foregoing description of embodiments of the inventive concepts, and it will be apparent that various changes may be made in the form, construction, and arrangement of the components thereof without departing from the broad scope of the inventive concepts disclosed herein or without sacrificing all of their material advantages; and individual features from various embodiments may be combined to arrive at other embodiments. The forms herein before described being merely explanatory embodiments thereof, it is the intention of the following claims to encompass and include such changes. Furthermore, any of the features disclosed in relation to any of the individual embodiments may be incorporated into any other embodiment.

What is claimed is:

1. A method for training a neural network comprising:
receiving a training data set;
producing an artificial training data set;
training a neural network on the artificial training data set until a global minimum error rate is reached; and
iteratively modify the artificial training data set to approach the training data set and training the neural network on the modified artificial training data set until an updated global minimum error rate is reached, until the artificial training data set coincides with the training data set,
wherein the artificial training data set is configured to train the neural network to reach the global minimum error rate.

2. The method of claim 1, further comprising:
training the neural network on the training data set to at least a predefined error rate;
dividing the training data set between a set of correctly trained data elements and a set of incorrectly trained data elements;
replacing each incorrectly trained data element in the set of incorrectly trained data elements with a corresponding cloned data element from the set of correctly trained data elements;
combining the correctly trained data elements and cloned data elements to produce the artificial training data set; and
creating a hybrid data set as a weighted average of the artificial training data set and the training data set.

3. The method of claim 2, wherein iteratively modifying the artificial training data set comprises adjusting a weight of the weighted average to produce a new artificial training data set.

4. The method of claim 1, further comprising:
determining, after modifying the artificial training data set, that the modified artificial training data set does not produce an updated global minimum error rate;
reverting to a prior iteration of the modified training data set; and
reducing a modifying factor for at least one subsequent iteration.

5. The method of claim 1, further comprising:
determining, after modifying the artificial training data set, that the modified artificial training data set produces two or more consecutive iterations that reach the global minimum error rate; and
increasing the modifying factor for at least one subsequent iteration.

6. The method of claim 1, wherein:
the training data set comprises a collection of disparate data types with shared labels; and
the artificial training data set comprises data elements cloned from like type data elements.

7. The method of claim 1, wherein the neural network is trained to arbitrarily low error rates.

8. A system comprising at least one processor embodying a trained neural network, the neural network trained by:
receiving a training data set;
producing an artificial training data set;
training the neural network on the artificial training data set until a global minimum error rate is reached; and
iteratively modify the artificial training data set to approach the training data set and training the neural network on the modified artificial training data set until an updated global minimum error rate is reached, until the artificial training data set coincides with the training data set,
wherein the artificial training data set is configured to train the neural network to reach the global minimum error rate.

9. The system of claim 8, wherein the neural network is further trained by:
training the neural network on the training data set to at least a predefined error rate;
dividing the training data set between a set of correctly trained data elements and a set of incorrectly trained data elements;
replacing each incorrectly trained data element in the set of incorrectly trained data elements with a corresponding cloned data element from the set of correctly trained data elements;
combining the correctly trained data elements and cloned data elements to produce the artificial training data set; and
creating a hybrid data set as a weighted average of the artificial training data set and the training data set.

10. The system of claim 9, wherein the cloned data element is a closest correctly trained data element.

11. The system of claim 9, wherein iteratively modifying the artificial training data set comprises adjusting a weight of the weighted average to produce a new artificial training data set.

12. The system of claim 8, wherein the neural network is further trained by:
determining, after modifying the artificial training data set, that the modified artificial training data set does not produce an updated global minimum error rate;
reverting to a prior iteration of the modified training data set; and
reducing a modifying factor for at least one subsequent iteration.

13. The system of claim 8, wherein the neural network is further trained by:
determining, after modifying the artificial training data set, that the modified artificial training data set produces two or more consecutive iterations that reach the global minimum error rate; and
increasing the modifying factor for at least one subsequent iteration.

14. The system of claim 8, wherein:
the training data set comprises a collection of disparate data types with shared labels; and
the artificial training data set comprises data elements cloned from like type data elements.

15. A computer apparatus for training a neural network comprising:
a data storage element;
at least one processor in data communication with the data storage element and a memory storing non-transitory processor executable code to configure the at least one processor to:
receive a training data set from the data storage element;
produce an artificial training data set;
train a neural network on the artificial training data set until a global minimum error rate is reached; and
iteratively modify the artificial training data set to approach the training data set and training the neural network on the modified artificial training data set until an updated global minimum error rate is reached, until the artificial training data set coincides with the training data set,
wherein the artificial training data set is configured to train the neural network to reach the global minimum error rate.

16. The computer apparatus of claim 15, wherein the at least one processor is further configured to:
train the neural network on the training data set to at least a predefined error rate;
divide the training data set between a set of correctly trained data elements and a set of incorrectly trained data elements;
replace each incorrectly trained data element in the set of incorrectly trained data elements with a corresponding cloned data element from the set of correctly trained data elements; and
combine the correctly trained data elements and cloned data elements to produce the artificial training data set; and
creating a hybrid data set as a weighted average of the artificial training data set and the training data set.

17. The computer apparatus of claim 16, wherein iteratively modifying the artificial training data set comprises adjusting a weight of the weighted average to produce a new artificial training data set.

18. The computer apparatus of claim 15, wherein the at least one processor is further configured to:
determine, after modifying the artificial training data set, that the modified artificial training data set does not produce an updated global minimum error rate;
revert to a prior iteration of the modified training data set; and
reduce a modifying factor for at least one subsequent iteration.

19. The computer apparatus of claim 15, wherein the at least one processor is further configured to:
determine, after modifying the artificial training data set, that the modified artificial training data set produces two or more consecutive iterations that reach the global minimum error rate; and
increase the modifying factor for at least one subsequent iteration.

20. The computer apparatus of claim 15, wherein:
the training data set comprises a collection of disparate data types with shared labels; and
the artificial training data set comprises data elements cloned from like type data elements.
